(19) United States
(12) Patent Application Publication
(10) Pub. No.: US 2006/0146795 A1
(43) Pub. Date: Jul. 6, 2006

(54) Universal port user agent capable of caching route information among sessions and associated method

(75) Inventors: Gigo K. Joseph, Arlington Heights, IL (US); Devarajan S. Puthupparambil, Mount Prospect, IL (US)

Correspondence Address: PATENTS AND LICENSING LLC;DANIEL W. JUFFERNBRUCH, 28 BARRINGTON BOURNE, BARRINGTON, IL, 60010-9605, US

(73) Assignee: UTStarcom, Inc., Alameda, CA (US)

(21) Appl. No.: 11/027,316

(22) Filed: Dec. 31, 2004

(51) Int. Cl. H04L 12/66

(52) U.S. Cl. 370/352

(57) ABSTRACT

An initial call is setup by a universal port user agent by sending an invitation to the proxy server. The proxy server performs a directory lookup from a back end server to obtain route information to a destination. The route information is passed to the universal port user agent in response and is stored in the universal port user agent. When subsequent calls to the same destination are requested, the subsequent calls can be setup using the stored route information. A universal port user agent performs these call setups. The route information memory is managed based on a number of routes stored and the age of the stored routes. In certain embodiments the calls are setup using the Session Initiation Protocol (SIP).

### BACKGROUND OF THE INVENTIONS

1. Technical Field

The present inventions relate to communications and, more particularly, relate to communications systems having route mechanisms.

2. Description of the Related Art

The Internet Engineering Taskforce (IETF) has published a Request for Comments (RFC) setting forth the specifications for the Session Initiation Protocol known as SIP. This RFC is “SIP: Session Initiation Protocol,” RFC 3261, by J. Rosenberg et. al., June 2002.

The Session Initiation Protocol (SIP) is an application-layer control (signaling) protocol for creating, modifying, and terminating sessions with one or more participants. These sessions include Internet telephone calls, multimedia distribution, and multimedia conferences.

The Session Initiation Protocol (SIP) provides for creating, modifying, and terminating sessions with participants one at a time. If you need to repeat a session wih the same destination, the call must be setup again following the same procedure.

No method is available to setup subsequent sessions to a same destination other than to repeat the call setup process in its entirety.

### SUMMARY OF THE INVENTIONS

An object of the present inventions is to reduce network usage.

A further object of the present inventions is to eliminate redundant querying.

Another further object of the present inventions is to increase connect rate by eliminating some back end server database queries.

Another object of the present inventions is to provide for storage of route information for use in subsequent sessions.

A further other object of the present inventions is to setup subsequent calls to the same destination using the stored route information.

An additional object of the present inventions is to report an end point's contact information to a Session Initiation Protocol (SIP) proxy server based on a universal port SIP user agent's experience.

An initial call is setup by a universal port user agent by sending an invitation to the proxy server. The proxy server performs a directory lookup from a back end server to obtain route information to a destination. The route information is passed to the universal port user agent in response and is stored in the universal port user agent. When subsequent calls to the same destination are requested, the subsequent calls can be setup using the stored route information. A universal port user agent performs these call setups. The route information memory is managed based on a number of routes stored and the age of the stored routes. In certain embodiments the calls are setup using the Session Initiation Protocol (SIP).

The details of the preferred embodiments and these and other objects and features of the inventions will be more readily understood from the following detailed description when read in conjunction with the accompanying drawings wherein:

### BRIEF DESCRIPTION OF THE DRAWINGS

FIG. 1 illustrates a schematic block diagram of a communication system according to the present inventions;

FIG. 2 illustrates a flow diagram of exemplary call flows for an initial call in the communications system of the present inventions; and

FIG. 3 illustrates a flow diagram of exemplary call flows for subsequent calls in the communications system of the present inventions.

### DETAILED DESCRIPTION OF THE PREFERRED EMBODIMENTS

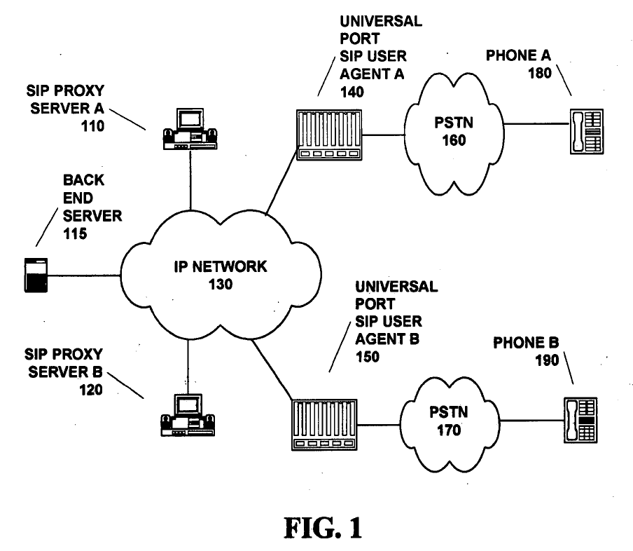

FIG. 1 illustrates a schematic block diagram of a communication system according to the present inventions. Phone A 180 connects through a public switched telephone network (PSTN) 160 to a universal port SIP user agent A 140. Phone B 190 connects through a public switched telephone network (PSTN) 170 to universal port SIP user agent B 150. The universal port SIP user agent A 140 and universal port SIP user agent B 150 connect to one another via an Internet Protocol (IP) network 130. The universal port SIP user agent A 140 is served by a SIP proxy server A 110 over an Internet Protocol (IP) network 130. The universal port SIP user agent B 150 is served by a SIP proxy server B 120 over an Internet Protocol (IP) network 130.

The universal port SIP user agent A 140 sets up a session from phone A 180 to phone B 190. An initial session is set up by the universal port SIP user agent 140 by sending a SIP INVITE to the SIP proxy server A 110. The SIP proxy server A 110 performs a directory lookup from a back end server 115 to obtain route information to a destination such as phone B 190. The route information is present in the SIP INVITE response from the SIP proxy server A 110 to the universal port user agent 140 and is stored in the universal port SIP user agent 140.

When subsequent sessions to the same destination phone B 190 are requested by the universal port SIP user agent 140, the subsequent sessions can be setup using this stored route information. Although in the preferred embodiment of FIG. 1 SIP user agents and SIP proxy servers are disclosed to handle SIP session setup and teardown messages, other session initiation schemes can be implemented such as H.323, for example.

The SIP proxy server A 110 and SIP proxy server B 120 are general purpose servers capable of routing SIP requests to user agent servers and SIP responses to user agent clients for setup of a session between two client devices such as phone A 180 and phone B 190.

The phone A 180 and phone B 190 are conventional telephone clients in the preferred embodiment as connect to a PSTN. In an alternative embodiment, the phone A 180 and phone B 190 can be IP telephones or other kinds of client devices, such as computing devices running media applications, that couple to a universal port or gateway without a PSTN and instead over a protocol such as an Internet Protocol (IP).

The universal port SIP user agent A 140 and universal port SIP user agent B 150 are gateways constructed in the preferred embodiment of processor cards and port cards on a chassis such as the Total Control 1000® by UTStarcom, Inc. The Total Control 1000® chassis consists of one network management card and up to 16 application cards, each application card providing, for example, digital signal processors for coupling to a public switched telephone network (PSTN) for analog modem dial-up access lines or Voice over IP (VoIP) connections. The universal port user agent resides in media gateway applications. The media gateway applications run on the ARC (access router card) of the Total Control 1000® chassis.

The term ‘universal port’ in the phrase ‘universal port SIP user agent’ means a universal port gateway. A universal port gateway is the same as a multi port gateway or multi access gateway. When the universal port gateway is used for creating, modifying, and terminating sessions with one or more participants in a multimedia environment, it is a universal port user agent. These sessions include internet telephone calls, multimedia distribution, and multimedia conferences.

The route information memory is managed based on a number of routes cached and the age of the cached routes. If the cached route information leads to a successful connection of a subsequent call, the cached time of call information is updated with the new time and a call counter value is incremented. If the cached route information turns out to be irrelevant for a call, the cache entry will be updated with the new route information and time of call values and the call counter value will be reset.

The probability for a frequently called destination to be called again is far greater than a sparsely called destination to be called again. Applying this statistic it is possible to remove entries from the memory based on the time of call value of the entries cached.

The cached information is preferably managed by a refreshing mechanism and an aging mechanism to not only properly maintain the data but also limit the data volume from crossing extreme limits.

The ARC (access router card) will build a knowledge pattern based on the acceptance of the cached routes and will use this as criteria for sending the stored route information. The cached route information is updated or modified based on the relevance of the stored information as observed in subsequent call transactions.

The call counter together with the time of call value can be of purpose for deciding on the deletion of cache entries in the event of a cache sweep due to cache management activities or entry count limitations.

When utilizing the route information from a previous session there is the possibility of any changes that may have happened to the actual routes that may not be reflected in the cached information. The time of call information retained can be of help here. This can be used effectively to make a judicious decision on whether the routes will be still relevant.

As an example, route information not used again for a relatively long time and having a very low call counter value has a very high chance of being irrelevant and it would be better not to forward that route information. On the other hand, a recently used call entry in the cache with a high call counter value will surely be having relevant route information and can be forwarded.

For every call made through the universal port SIP user agent, the universal port SIP user agent will retain the latest routing information; most likely at the time of call connect. This information will be cached in the ARC (access router card) associated with the universal port SIP user agent with proper identification using the DNIS and time of call along with the Route information. When a new call arrives, the ARC (access router card) will then query the DNIS number in its cache. If present and usable, the ARC (access router card) will pick up the stored route information and append this information to a call setup message sent to the SIP proxy server. The route information preferably includes the time of call of the last call and the SIP header for the Route/Contact.

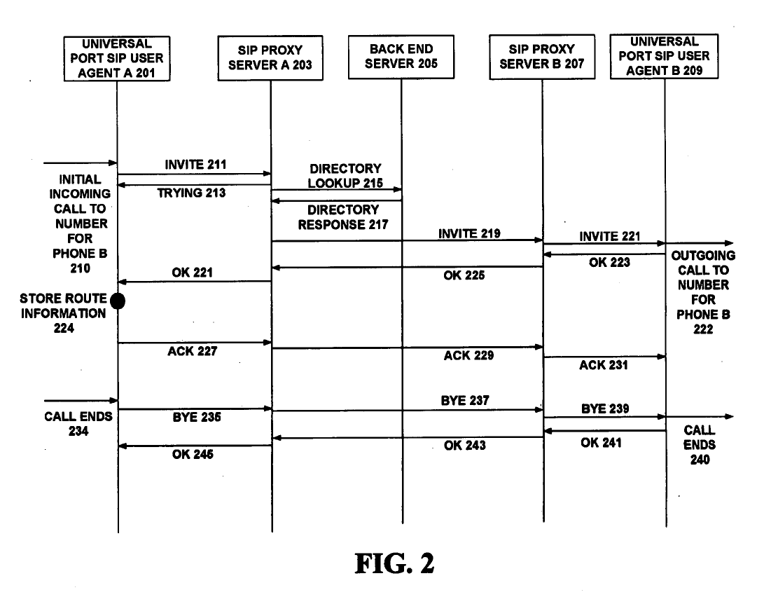

FIG. 2 illustrates a flow diagram of exemplary call flows for an initial call in the communications system of the present inventions. At step 210, a universal port SIP user agent A 201 receives an initial incoming call to the destination number for phone B. The destination number in the session initiation protocol (SIP) is represented as a ‘DNIS number’ for a phone. At step 211 the universal port SIP user agent A 201 issues an INVITE message to a SIP proxy server A 203. The SIP proxy server A 203 issues a trying message at step 213 to the universal port SIP user agent A 201. A trying message in the session initiation protocol (SIP) is a ‘SIP 100’ message. After step 213, the SIP proxy server A 203 issues a directory lookup message to a back end server 205 at step 215. Thereafter, the back end server 205 issues a directory response message to the SIP proxy server A 203 at step 217. Then the SIP proxy server A 203 issues an INVITE message to the SIP proxy server B 207 at step 219. Then the SIP proxy server B 207 issues an INVITE message to another universal port SIP user agent B 209 and an outgoing call to the number for a destination phone B is made at step 222.

After the outgoing call to the number for a destination phone B is made at step 222, the universal port set user agent B 209 then issues an OK message to the SIP proxy server B 207 at step 223. An OK message in the session initiation protocol (SIP) is a ‘SIP 200’ message. The SIP proxy server B 207 then issues an OK message to the SIP proxy server A 203 at step 225. SIP proxy server A 203 then issues an OK message to the universal port SIP user agent A 201 at step 221 containing the route information for the Phone B 190.

The OK message received at step 221 by the universal port SIP user agent A 201 contained the route information for the Phone B 290. The universal port SIP user agent A 201 at step 224 stores in cache memory the route information for the call to the destination phone B 290. This route information is then available for subsequent calls to the destination phone B 290.

The universal port SIP user agent A 201 then issues an acknowledgment message to the SIP proxy server A 203 at step 227. The SIP proxy server A 203 then issues an acknowledgement message to the SIP proxy server B 207 at step 229. The SIP proxy server B 207 then issues an acknowledgement message to the universal port SIP user agent B 209 at step 231.

When the call ends by a message from a sending client to the universal ports SIP user agent 201 at step 234, the universal port SIP user agent 201 issues a bye message to the SIP proxy server A 203 at step 235. The SIP proxy server 203 then issues a bye message to the SIP proxy server B 207 at step 237. Then the SIP proxy server B 207 issues a bye message to the universal port SIP user agent B 209 at step 239. Then the universal port SIP user agent B 209 ends the call at step 240. Thereafter, the universal port SIP user agent B 209 sends an OK message to the SIP proxy server B 207 at step 241. Then the SIP proxy server B 207 issues an OK message to the SIP proxy server A 203 at step 243. Then the SIP proxy server A 203 issues an OK message to the universal SIP user agent A 201 at step 245.

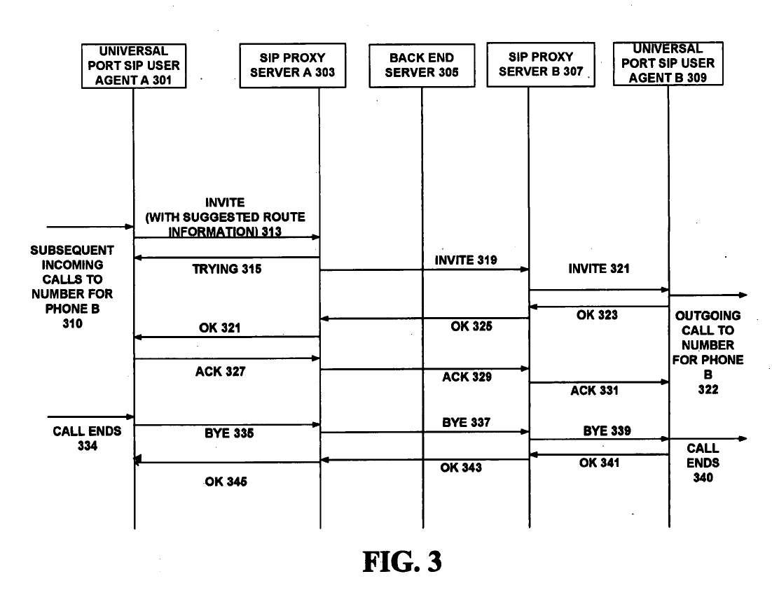

FIG. 3 illustrates a flow diagram of exemplary call flows for subsequent calls in the communications system of the present inventions. At step 310, a universal port SIP user agent A 301 receives a subsequent first incoming call to the destination number for phone B. The destination number in the session initiation protocol (SIP) is represented as a ‘DNIS number’ for a phone. At step 313 the universal port SIP user agent A 301 issues an INVITE message to a SIP proxy server A 303 containing suggested route information from the cached route information.

The SIP proxy server A 303 issues a trying message at step 315 to the universal port SIP user agent A 301. A trying message in the session initiation protocol (SIP) is a ‘SIP 100’ message. The SIP proxy server A 303 does not need to issues a directory lookup message to the back end server assuming the suggested route information allow the destination phone to be reached.

Using the suggested route information from the universal port user agent's cache present in the SIP INVITE received at step 313, the SIP proxy server A 303 issues an INVITE message to the SIP proxy server B 307 at step 319. No query of the back end server 305 is needed for the route information on these subsequent calls. This saves time and system resources.

The SIP proxy server B 307 then issues an INVITE message at step 321 to another universal port SIP user agent B 309 and an outgoing call to the number for a destination phone B is made at step 322.

After the outgoing call to the number for a destination phone B is made at step 322, the universal port set user agent B 309 then issues an OK message to the SIP proxy server B 307 at step 323. An OK message in the session initiation protocol (SIP) is a ‘SIP 200’ message. The SIP proxy server B 307 then issues an OK message to the SIP proxy server A 303 at step 325. SIP proxy server A 303 then issues an OK message to the universal port SIP user agent A 301 at step 321.

The universal port SIP user agent A 301 then issues an acknowledgment message to the SIP proxy server A 303 at step 327. The SIP proxy server A 303 then issues an acknowledgement message to the SIP proxy server B 307 at step 329. The SIP proxy server B 307 then issues an acknowledgement message to the universal port SIP user agent B 309 at step 331.

When the call ends by a message from a sending client to the universal ports SIP user agent 301 at step 334, the universal port SIP user agent 301 issues a bye message to the SIP proxy server A 303 at step 335. The SIP proxy server A 303 then issues a bye message to the SIP proxy server B 307 at step 337. Then the SIP proxy server B 307 issues a bye message to the universal port SIP user agent B 309 at step 339. Then the universal port SIP user agent B 309 ends the call at step 340. Thereafter, the universal port SIP user agent B 309 issues an OK message to the SIP proxy server B 307 at step 341. Then the SIP proxy server B 307 issues an OK message to the SIP proxy server A 303 at step 343. Then the SIP proxy server A 303 issues an OK message to the universal SIP user agent A 301 at step 345.

A universal port SIP user agent can contribute to reducing the connect speed of the VoIP calls by an efficient mechanism to cache the relevant information of previous calls through it. The universal port SIP user agent can cache the route information for a particular destination for a given session and forward the cached route information to a SIP proxy server as the suggested route for subsequent sessions to the same destination. This way the universal port SIP user agent can accelerate the call connection mechanisms (SIP proxy server can avoid doing a route lookup to the back end server) and accelerate call setup time for subsequent calls to same destination.

The Internet Engineering Taskforce (IETF) as published a Request for Comments (RFC) setting forth the specifications for the Session Initiation Protocol known as SIP. This RFC is “SIP: Session Initiation Protocol,” RFC 3261, by J. Rosenberg et. al., June 2002. The most pertinent portions of RFC 3261 are sections 1-9, 12-17 and 24.

Cached information can be send to the proxy with either of the following headers:

Suggested-Route: <domain name>; last_used:<time>

Suggested-Contact:<domain name>; last_used:<time>

wherein the <domain name> is the name of the destination's domain which is cached from the previous call, and

wherein the <time represents> is the time at which the call was made previously and is computed as seconds from Epoch time.

An example is:

Suggested-Contact: biloxy.atlanta.com; last_used: 1102169072

Instead of a domain name such as ‘biloxy.atlanta.com’, an IP address can be present such as ‘200.120.35.4’.

Because the universal port SIP user agent learns the route information of the end point from successive calls and forwards it to the SIP Proxy server, call setup time is reduced and network efficiency is increased. When the universal port SIP user agent offers stored route information for subsequent calls to repeat destination numbers, the proxy server can save the time required to query the route for this call. The chance that the route has undergone change is pretty small. The proxy server may also choose to disregard the information from the universal port SIP user agent and proceed with its normal querying if it configured to do so.

Even when the proxy server chooses to proceed with its querying, the proxy server can still optimize its own query by using the time of call value present in the stored route information. To do so, the proxy server would need to check only those new route updates that have happened since the time of call value for any route modifications to the sought destination. If there is no such route update present, the value forwarded by the universal port SIP user agent can be used. In case there is a route update present, then the new route information will be updated by the universal port SIP user agent in its route cache at the call tear down time.

Although the inventions have been described and illustrated in the above description and drawings, it is understood that this description is by example only, and that numerous changes and modifications can be made by those skilled in the art without departing from the true spirit and scope of the inventions. Although the examples in the drawings depict only example constructions and embodiments, alternate embodiments are available given the teachings of the present patent disclosure. For example, although wireless examples are disclosed, the inventions are applicable to session establishments from IP to IP or Wireline PSTN and cellular communications.

What is claimed is:

1. A method of setting up sessions comprising the steps of:
(a) storing route information for a first session to a destination; and
(b) setting up a second session to the same destination using the stored route information.

2. A method according to claim 1, wherein said step (a) of storing route information for a session to a destination comprises the substeps of (a1) performing a directory lookup to determine a route to the destination and (a2) retaining the route for subsequent sessions.

3. A method according to claim 2, wherein said step (a1) of performing a directory lookup performs the directory lookup from a back end server.

4. A method according to claim 1, wherein said step (a) of storing route information retains the route so long as an ok is received from the destination.

5. A method according to claim 1, wherein said step (a) of storing route information also stores the time of the first session.

6. A method according to claim 1, wherein said step (a) of storing route information also stores the address of the destination.

7. A method according to claim 6, wherein said step (a) of storing the route information for the destination stores a DNIS of the destination.

8. A method according to claim 1, further comprising the step of (c) comparing a current condition against a stored past condition associated with the route information to determine whether to continue storing the route information.

9. A method according to claim 8, wherein said step (c) of comparing compares a current time against a stored time of the first session.

10. A method according to claim 8, wherein said step (c) of comparing compares a current count against a stored time of the first session.

11. A method according to claim 1,
wherein said step (a) of storing route information for a session to a destination increments a counter for each stored route; and
wherein the method further comprises a step of (c) comparing the counter to a maximum number to determine whether to continue storing the route information.

12. A method according to claim 1, wherein said step (a) of storing route information stores the route information in a user agent.

13. A method according to claim 1, wherein the sessions in steps (a) and (b) are implemented in SIP.

14. A method according to claim 1, wherein said step (a) of storing route information stores the route information in a universal port user agent.

15. A method according to claim 1, further comprising the step of (c) When a server is unwilling to use a route of the route information for setup of a subsequent session to a same destination, the server still optimizes its own route query by using the time in the stored route information.

16. A method in a universal port user agent of setting up sessions comprising the steps of:
(a) for a session to a destination, storing route information obtained for the destination; and
(b) setting up a subsequent session to the same destination by using the stored route information.

17. A method according to claim 16, wherein said step (a) of storing route information stores the route information in the universal port user agent.

18. A method according to claim 16, further comprising the step of (c) when a proxy server is unwilling to use a route of the route information for setup of a subsequent session to a same destination, the proxy server still optimizes its own route query by using the time in the stored route information.

19. A method according to claim 16, wherein the sessions in steps (a) and (b) are implemented in SIP.

20. A universal port user agent for enabling setup of sessions, comprising a processor and communication ports to initially connect with a destination phone and store route information and to again connect with the same destination phone using the stored route information.
